(19) United States
(12) Patent Application Publication
(10) Pub. No.: US 2019/0289153 A1
(43) Pub. Date: Sep. 19, 2019

(54) INFORMATION PROCESSING APPARATUS, INFORMATION PROCESSING METHOD, AND NON-TRANSITORY STORAGE MEDIUM

(71) Applicant: Yusho KAKU, Kanagawa (JP)

(72) Inventor: Yusho KAKU, Kanagawa (JP)

(73) Assignee: Ricoh Company, LTD., Tokyo (JP)

(21) Appl. No.: 16/282,648

(22) Filed: Feb. 22, 2019

(30) Foreign Application Priority Data
Mar. 16, 2018 (JP) 2018-049363

(51) Int. Cl. H04N 1/00; G06F 1/3296

(52) U.S. Cl. CPC H04N 1/00888; H04N 1/00904; H04N 2201/0094; G06F 1/3296; H04N 1/00973

(57) ABSTRACT

An information processing apparatus includes first circuitry and second circuitry. The first circuitry is configured to transition to one of power states including a first power state, a second power state having higher power consumption than the first power state, and a third power state having higher power consumption than the second power state. The second circuitry is configured to input a first signal to the first circuitry via a first communication channel and input a second signal to the first circuitry via a second communication channel, the second communication channel being different from the first communication channel. When the first signal is input in the first power state, the first circuitry determines, in accordance with the second signal, which one of the second power state and the third power state to transition to.

### CROSS-REFERENCE TO RELATED APPLICATION

This patent application is based on and claims priority pursuant to 35 U.S.C. § 119(a) to Japanese Patent Application No. 2018-049363, filed on Mar. 16, 2018, in the Japan Patent Office, the entire disclosure of which is hereby incorporated by reference herein.

### BACKGROUND

### Technical Field

The present disclosure relates to an information processing apparatus, an information processing method, and a non-transitory storage medium storing a program.

### Description of the Related Art

A technique is known that causes the power state of an information processing apparatus to transition from a remote place. For example, using Wake-on-LAN technology, a magic packet is transmitted to an information processing apparatus connected to a local area network (LAN) from another apparatus connected to the LAN. In response to receiving the magic packet, the information processing apparatus returns from a power-saving state to a predetermined power state (hereinafter referred to as “post-return power state”).

### SUMMARY

An information processing apparatus includes first circuitry and second circuitry. The first circuitry is configured to transition to one of power states including a first power state, a second power state having higher power consumption than the first power state, and a third power state having higher power consumption than the second power state. The second circuitry is configured to input a first signal to the first circuitry via a first communication channel and input a second signal to the first circuitry via a second communication channel, the second communication channel being different from the first communication channel. When the first signal is input in the first power state, the first circuitry determines, in accordance with the second signal, which one of the second power state and the third power state to transition to.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is an explanatory diagram of the hardware configuration of a multifunction peripheral as an example of an information processing apparatus, according to an embodiment of the present disclosure;

FIG. 2 is an explanatory diagram of an example of various signals transmitted and received, according to a first embodiment of the present disclosure;

FIG. 3 is a functional block diagram of the multifunction peripheral as an example of the information processing apparatus, according to an embodiment of the present disclosure;

FIG. 4 is an explanatory diagram of an example of a power state, according to an embodiment of the present disclosure;

FIG. 5 is an explanatory diagram of a return flag, a state control signal, and transition of a power state, according to the first embodiment of the present disclosure;

FIG. 6 is an explanatory sequence diagram of a specific example until the power state returns, according to the first embodiment of the present disclosure;

FIG. 7 is an explanatory diagram of an example of various signals transmitted and received, according to a second embodiment of the present disclosure;

FIG. 8 is an explanatory diagram of a return flag, a state control signal, and transition of a power state, according to the second embodiment of the present disclosure; and

FIG. 9 is an explanatory sequence diagram of a specific example until the power state returns, according to the second embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present disclosure will be described in detail below with reference to drawings.

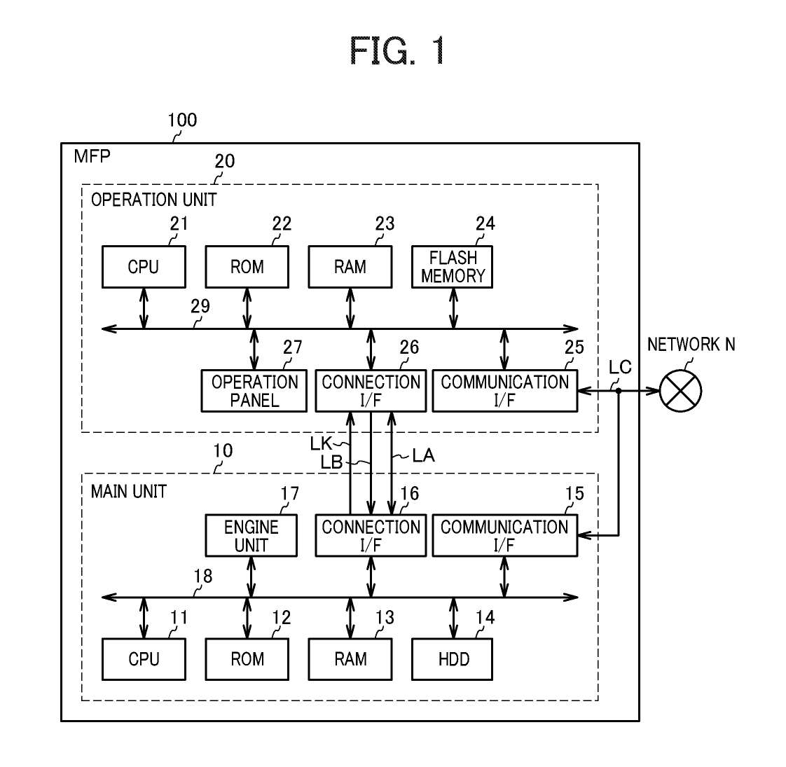

FIG. 1 is an explanatory diagram of the hardware configuration of a multifunction peripheral (MFP) 100 as an example of an information processing apparatus. As illustrated in FIG. 1, the multifunction peripheral 100 includes a main unit 10 and an operation unit 20.

As illustrated in FIG. 1, the main unit 10 includes: a central processing unit (CPU) 11; a read only memory (ROM) 12; a random access memory (RAM) 13; a hard disk drive (HDD) 14; a communication interface (I/F) 15; a connection I/F 16; and an engine unit 17. Each component is mutually communicable via, for example, a data bus. The hardware configuration of the main unit 10 can be appropriately changed.

The CPU 11 implements various functions (for example, a power state controller 113 to be described later) by executing the program. Instead of the CPU 11, a micro processing unit (MPU) may be adopted as a processor. The ROM 12 nonvolatilely stores various types of information including the program executed by the CPU 11. Information referred to when the CPU 11 executes the program is temporarily stored in the RAM 13. The HDD 14 nonvolatilely stores various types of information.

The multifunction peripheral 100 is provided with a power outlet. When the power outlet is connected to a commercial power supply, power supply to the main unit 10 starts. When the power supply starts, the main unit 10 returns from a power cut-off state to a predetermined power state. For example, when the power supply starts, the power state of the main unit 10 transitions to a suspended to ram (STR) state.

The STR state is a power-saving state in which power for maintaining the information stored in the RAM 13 is supplied, and in principle the other power supply stops. As will be described in detail later, the main unit 10 of the present embodiment transitions to a plurality of power states (STR state, engine-OFF state, silent state, low-power state, and standby state) with different power consumption.

The main unit 10 communicates with the operation unit 20 via a first signal line LA. The main unit 10 performs communication in compliance with the Ethernet (registered trademark) standard via the first signal line LA. For example, a twisted pair cable may be adopted as the first signal line LA. The main unit 10 receives various signals including a wakeup signal (an example of a “first signal”) from the operation unit 20 via the first signal line LA. Furthermore, the main unit 10 communicates with the operation unit 20 via a second signal line LB.

When receiving the wakeup signal, the main unit 10 causes the power state to transition (return). As will be described in detail later, when receiving the wakeup signal in the STR state, the main unit 10 returns to a power state of corresponding to the signal from the second signal line LB (any of engine-OFF state, silent state, low-power state, and standby state). In other words, the power state of the main unit 10 immediately after returning from the STR state varies in accordance with the signal from the second signal line LB.

As illustrated in FIG. 1, the main unit 10 is connected to the operation unit 20 via an activation signal line LK, in addition to the first signal line LA and the second signal line LB. When the power outlet described above is connected to the commercial power supply and the power supply to the main unit 10 starts, an activation signal is input to the operation unit 20 via the activation signal line LK.

When the activation signal is input, the operation unit 20 returns from the power cut-off state to a predetermined power state. For example, when the activation signal is input, the operation unit 20 transitions to a sleep state. The sleep state is a power-saving state in which power for maintaining the information stored in the RAM 23 is supplied, and in principle the other power supply stops.

The main unit 10 communicates with an external computer via a third signal line LC. Specifically, one end of the third signal line LC is connected to the communication I/F 15 of the main unit 10. The other end of the third signal line LC is connected to a network N (local area network (LAN)). With the above configuration, the external computer connected to the network N is communicable with the main unit 10.

The external computer connected to the network N can transmit various data to the main unit 10. The main unit 10 executes a process corresponding to data from the external computer. For example, when receiving a print job from the external computer, the main unit 10 controls the engine unit 17 to print an image corresponding to the print job.

As illustrated in FIG. 1, the operation unit 20 includes: a CPU 21; a ROM 22; a RAM 23; a flash memory 24; a communication I/F 25; a connection I/F 26; and an operation panel 27. Each component is mutually communicable via, for example, a data bus. The hardware configuration of the operation unit 20 can be appropriately changed. The operation unit 20 can be detachable from the main unit 10. In another example, the operation unit 20 can be a terminal such as a smartphone or a tablet terminal that is used independently from the main unit 10.

The operation panel 27 is operated by a user of the multifunction peripheral 100. Specifically, the operation panel 27 includes a liquid crystal display device. The liquid crystal display device displays various images including a button image. Appropriate operation of the button image by the user can cause the multifunction peripheral 100 to operate (for example, execute printing). The liquid crystal display device is adopted as a display device that displays various images; however, other displays may be adopted.

The CPU 21 implements various functions (for example, a power state controller 123 to be described later) by executing a program. Instead of the CPU 21, an MPU may be adopted as a processor. The ROM 22 nonvolatilely stores various types of information including the program executed by the CPU 21. Information referred to when the CPU 21 executes the program is temporarily stored in the RAM 23. The flash memory 24 nonvolatilely stores various types of information.

The operation unit 20 communicates with the external computer of the multifunction peripheral 100 via the network N by the communication I/F 25. Similarly to the communication I/F 15 of the main unit 10 described above, the third signal line LC is connected to the communication I/F 25 of the operation unit 20. The first signal line LA and the second signal line LB are connected to the connection I/F 26 of the operation unit 20.

In the present embodiment, Wake-on-LAN technology is adopted, and operation of the external computer connected to the LAN (network N) allows the power state of the operation unit 20 to return from the sleep state. Specifically, operation of the external computer enables transmission of a magic packet to the operation unit 20. When receiving the magic packet, the operation unit 20 returns from the sleep state.

When the operation unit 20 returns from the sleep state, a wakeup signal is input to the main unit 10, and the power state of the main unit 10 returns. The trigger at which the wakeup signal is input to the main unit 10 can be appropriately changed. For example, the operation unit 20 may be provided with a power-saving state return button, and when the power-saving state return button is operated, the wakeup signal may be input to the main unit 10.

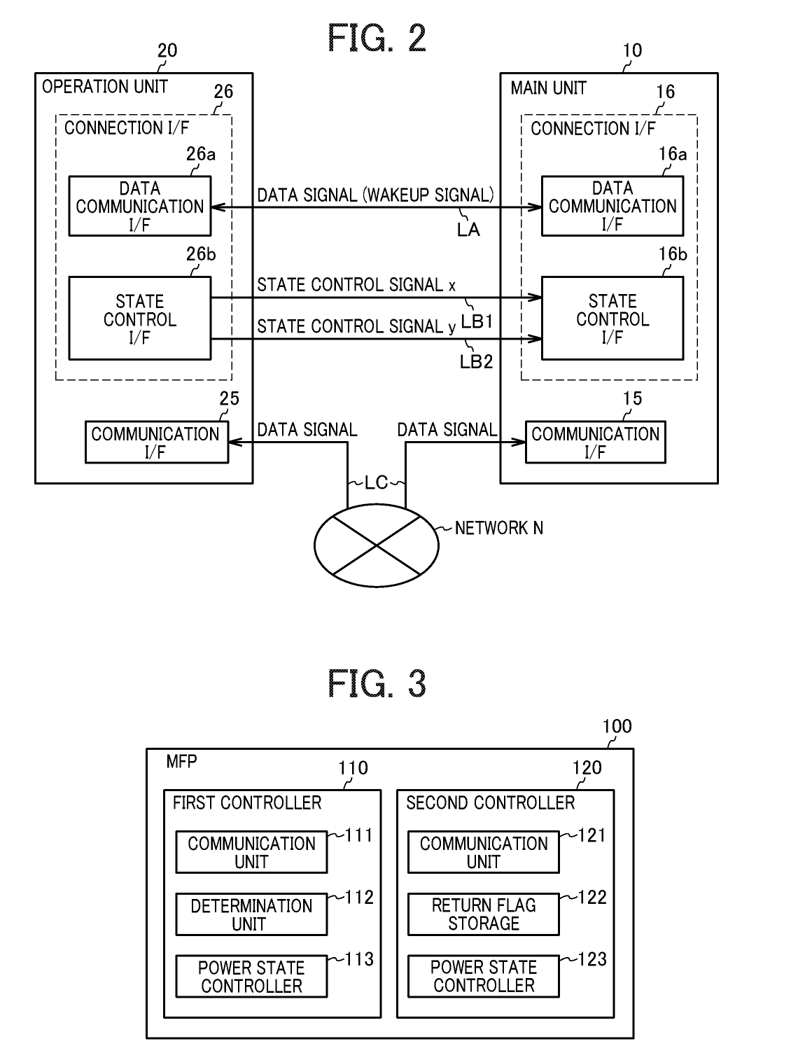

FIG. 2 is an explanatory diagram of an example of various signals transmitted and received in the main unit 10 and the operation unit 20.

As illustrated in FIG. 2, the third signal line LC is connected to the communication I/F 25 of the operation unit 20, and a data signal is input from the network N. As the communication I/F 25, for example, a network card (LAN card) is adopted. However, other than the network card may be adopted as the communication I/F 25.

The data signal from the network N is received by the operation unit 20 as packet information. As the data signal, for example, a magic packet for returning the power state of the operation unit 20 from the sleep state is assumed. Even with the multifunction peripheral 100 shut down (power-saving state), power is supplied to the network card, and the operation unit 20 can receive the magic packet. Similarly to the communication I/F 25 of the operation unit 20, the packet information is input from the network N to the communication I/F 15 of the main unit 10.

As illustrated in FIG. 2, the connection I/F 16 of the main unit 10 includes a data communication I/F 16a and a state control I/F 16b. The connection I/F 26 of the operation unit 20 includes a data communication I/F 26a and a state control I/F 26b. Similarly to the communication I/F 25 described above, a network card is adopted as the data communication I/F 16a and the data communication I/F 26a. However, other than the network card may be included in the data communication I/F 16a and the data communication I/F 26a. Furthermore, the connection I/F 16 and the connection I/F 26 include the first signal line LA and the second signal line LB. However, the connection I/F 16 and the connection I/F 26 may transmit and receive the wakeup signal and a state control signal to be described later with wireless communication instead of wired communication. The data communication I/F 16a and the data communication I/F 26a are examples of a first receiver, and the state control I/F 16b and the state control I/F 26b are examples of a second receiver.

The data communication I/F 16a and the data communication I/F 26a transmit and receive various data signals via the first signal line LA. The data signals transmitted via the first signal line LA include, for example, various types of information for printing an image. The data signals transmitted from the operation unit 20 to the main unit 10 include the wakeup signal.

Even when the main unit 10 is in the STR state, power is supplied to the network card included in the data communication I/F 16a. Therefore, even when the main unit 10 is in the STR state, the wakeup signal is received by the data communication I/F 16a. In the STR state of the main unit 10, when a signal other than the wakeup signal is input to the data communication I/F 16a, the signal is discarded (not received).

The state control I/F 26b of the operation unit 20 outputs a state control signal (an example of a “second signal”). The state control signal output from the state control I/F 26b is input to the state control I/F 16b of the main unit 10 via the above-described second signal line LB. The state control signal controls (makes variable) the power state when the main unit 10 receives the wakeup signal.

As illustrated in FIG. 2, the second signal line LB of the present embodiment includes a plurality of signal lines. Specifically, the second signal line LB includes a second signal line LB1 and a second signal line LB2. A state control signal x is input from the operation unit 20 to the main unit 10 via the second signal line LB1. A state control signal y is input from the operation unit 20 to the main unit 10 via the second signal line LB2.

The state control signal x and the state control signal y change to an ON state or an OFF state. When transmitting the wakeup signal, the operation unit 20 turns each of the state control signals to the ON state or the OFF state. As will be described in detail later, the power state in which the main unit 10 returns is determined in accordance with any combinations of the states (ON/OFF) of the state control signals.

The I/Fs (15, 16a, or 16b) of the main unit 10 can be implemented a single device by different devices. In addition, the I/Fs (25, 26a, or 26b) of the operation unit 20 can be implemented by a single device or different devices.

FIG. 3 is a functional block diagram of the multifunction peripheral 100 according to the present embodiment. As illustrated in FIG. 2, the multifunction peripheral 100 includes a first controller 110 and a second controller 120. The above-described main unit 10 (CPU 11) executes the program to function as the first controller 110. The operation unit 20 (CPU 21) executes the program to function as the second controller 120.

As illustrated in FIG. 3, the first controller 110 includes a communication unit 111, a determination unit 112, and a power state controller 113. The second controller 120 includes a communication unit 121, a return flag storage 122, and a power state controller 123. The communication unit 121 of the second controller 120 transmits the above-described wakeup signal and state control signals to the first controller 110. The communication unit 111 of the first controller 110 receives the wakeup signal and the state control signals.

The return flag storage 122 of the second controller 120 stores a return flag. As will be described in detail later, there are provided a plurality of respective return flags (1 to 4) corresponding to the plurality of power states (engine-OFF state, silent state, low-power state, and standby state) of the first controller 110.

In the present embodiment, before the wakeup signal is output, a return flag is stored in advance in the return flag storage 122. For example, the return flag is stored in accordance with an appropriate user operation to the operation panel 27. In another example, the return flag is stored in the multifunction peripheral 100 in its development stage (before shipment) so that the user cannot change the return flag.

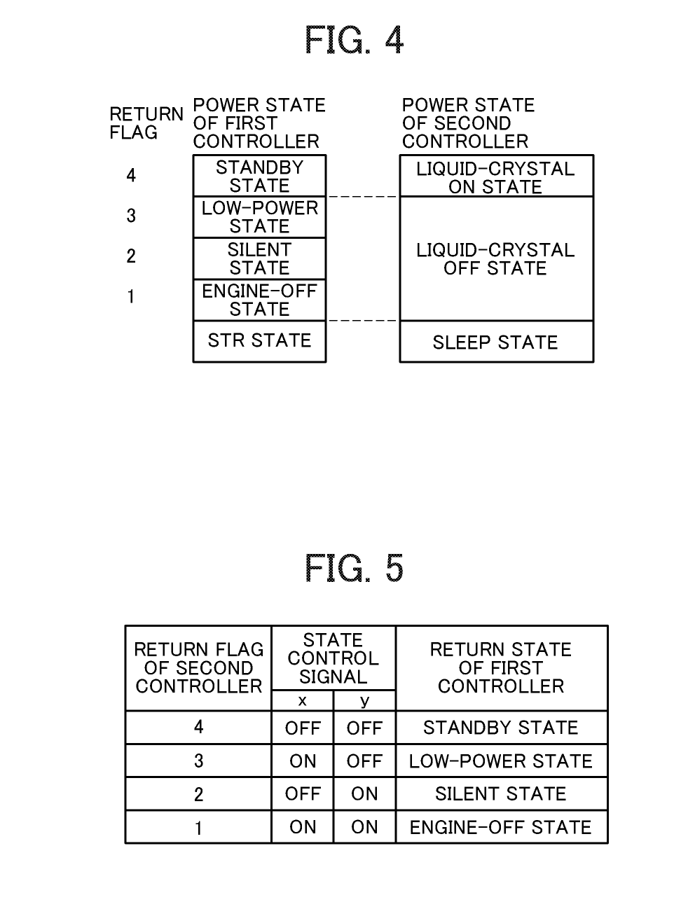

FIG. 4 is an explanatory diagram of the relationship between the return flag and the power state. The first controller 110 of the present embodiment transitions to the power state including the STR state (first power state), the engine-OFF state (second power state), the silent state (third power state), the low-power state, and the standby state. The power state to which the first controller 110 transitions can be appropriately changed.

The standby state is a power state in which power is supplied to all the power supply destinations in the first controller 110 (the main unit 10), and a state in which image printing and the like is immediately executable. The low-power state is a power state that can immediately transition to the standby state. In the low-power state, power for some of the components in the first controller 110 decreases. The silent state is a power state in which power supply to a cooling fan further stops in the low-power state.

The engine-OFF state is a power state in which power supply to the engine unit 17 further stops in the silent state. The STR state is a power state in which power for maintaining the information stored in the RAM 13 is supplied, and in principle power supply to each of the other components stops.

The power consumption of the first controller 110 increases in the order of the STR state, the engine-OFF state, the silent state, the low-power state, and the standby state. As illustrated in FIG. 4, the engine-OFF state corresponds to the return flag “1”, the silent state corresponds to the return flag “2”, the low-power state corresponds to the return flag “3”, and the standby state corresponds to the return flag “4”.

As will be described in detail later, the state control signals (x and y) corresponding to the return flag stored in the second controller 120 (return flag storage 122) are transmitted to the first controller 110. Upon receiving the state control signals, the first controller 110 returns to the power state corresponding to the return flag stored in the second controller 120. As described above, the return flag stored in the second controller 120 defines the power state after the return of the first controller 110.

As illustrated in FIG. 4, the second controller 120 transitions to the power state of a liquid-crystal ON state, a liquid-crystal OFF state, and the sleep state. The liquid-crystal ON state is a power state in which the liquid crystal display device is turned on. The liquid-crystal OFF state is a state in which power supply to the liquid crystal display device stops in the liquid-crystal ON state.

The sleep state is a power state in which the power for maintaining the information stored in the RAM 23 is supplied, and in principle power supply to each of the other components stops. The power consumption of the second controller 120 increases in the order of the sleep state, the liquid-crystal OFF state, and the liquid-crystal ON state. The power state to which the second controller 120 transitions can be appropriately changed.

In the present embodiment, when the first controller 110 is in the STR state, the second controller 120 enters the sleep state. In addition, when transmitting the wakeup signal to the first controller 110, the second controller 120 transitions to the power state corresponding to the return flag stored in the return flag storage 122. More specifically, when the return flag is the numerical value “1” to the numerical value “3”, the second controller 120 transitions to the liquid-crystal OFF state. Furthermore, when the return flag is the numerical value “4”, the second controller 120 transitions to the liquid-crystal ON state.

With the above configuration, when the first controller 110 returns to the engine-OFF state, the second controller 120 transitions to the liquid-crystal OFF state (return flag=1). However, when the first controller 110 transitions to the engine-OFF state, the second controller 120 may transition to the sleep state. Furthermore, when the first controller 110 transitions to the engine-OFF state, the second controller 120 may transition to the liquid-crystal ON state.

When the first controller 110 transitions to the silent state, the second controller 120 transitions to the liquid-crystal OFF state (return flag=2). When the first controller 110 transitions to the low-power state, the second controller 120 transitions to the liquid-crystal OFF state (return flag=3). However, when the first controller 110 transitions to the silent state or the low-power state, the second controller 120 may transition to the liquid-crystal ON state. When the first controller 110 transitions to the standby state, the second controller 120 transitions to the liquid-crystal ON state (return flag=4).

Referring again to FIG. 3, the power state controller 123 of the second controller 120 causes the power state to transition at a predetermined trigger. For example, when the magic packet is received from the network N, the power state controller 123 causes the power state to transition. Specifically, the power state controller 123 causes the power state of the second controller 120 to transition in accordance with each return flag stored in the return flag storage 122 (see FIG. 4 described above).

When the magic packet is received from the network N, the power state controller 123 of the second controller 120 changes the state (ON/OFF) of each of the state control signal x and the state control signal y, in accordance with the return flag stored in the return flag storage 122. Furthermore, the power state controller 123 of the second controller 120 causes the communication unit 121 to transmit the wakeup signal.

When receiving the wakeup signal, the determination unit 112 of the first controller 110 determines the power state to which the first controller 110 transitions. Specifically, when receiving the wakeup signal, the determination unit 112 determines the power state to which the first controller 110 transitions, in accordance with the state control signal x and the state control signal y. The power state controller 113 causes the first controller 110 to transition to the power state determined by the determination unit 112.

FIG. 5 is an explanatory diagram of the return flag stored by the second controller 120 (return flag storage 122), the state of the state control signals (x and y) when the wakeup signal is transmitted, and the transition of the power state of the first controller 110 (power state after return) when the state control signals are input.

As illustrated in FIG. 5, when the return flag of the second controller 120 is “4”, the state control signal x is in the OFF state and the state control signal y is in the OFF state at the time when the wakeup signal is transmitted. In the above case, the power state of the first controller 110 returns to the standby state.

When the return flag of the second controller 120 is “3”, the state control signal x is in the ON state and the state control signal y is in the OFF state at the time when the wakeup signal is transmitted. In the above case, the power state of the first controller 110 returns to the low-power state.

When the return flag of the second controller 120 is “2”, the state control signal x is in the OFF state and the state control signal y is in the ON state at the time when the wakeup signal is transmitted. In the above case, the power state of the first controller 110 returns to the silent state.

When the return flag of the second controller 120 is “1”, the state control signal x is in the ON state and the state control signal y is in the ON state at the time when the wakeup signal is transmitted. In the above case, the power state of the first controller 110 returns to the engine-OFF state.

As described above, according to the present embodiment, when receiving the wakeup signal (first signal) in the STR state (first power state), the first controller 110 transitions in power state in accordance with the state control signals (second signals). According to the above configuration, changing of the state of the state control signals brings the advantage that the power state to which the first controller 110 transitions (returns) is changeable.

Note that the first controller 110 of the present embodiment receives the wakeup signal in the STR state to transition to another power state. However, the first controller 110 may receive the wakeup signal in a power state different from the STR state (for example, engine-OFF state) to transition to another power state. That is, in the present embodiment, the STR state is assumed as the “first power state”; however, another power state may be adopted as the “first power state”.

In addition, the second signal line LB (communication channel of the state control signal) of the present embodiment includes the plurality of signal lines. The power state to which the first controller 110 returns is determined in accordance with the combinations of the signals received via the plurality of signal lines. According to the above configuration, for example, as compared with a case of a single signal line included in the second signal line LB, the number of power states to which the first controller 110 returns can be increased.

However, when a wakeup signal is received, the power state of the first controller 110 may be determined in accordance with the state (ON/OFF) of one state control signal. With the above configuration, the first controller 110 can return to any of two power states.

Furthermore, when a wakeup signal is received, the power state of the first controller 110 may be determined in accordance with the states of three or more state control signals. With the above configuration, the first controller 110 can return to any of eight or more power states.

Meanwhile, in the above first embodiment, when the power state returns, the main unit 10 and the operation unit 20 perform communication using the Ethernet (registered trademark) standard via the first signal line LA. However, the above configuration may be appropriately changed. For example, a high-speed serial bus such as a universal serial bus (USB) may be adopted as the first signal line LA.

However, the high-speed serial bus requires a relatively large amount of power in order to maintain a communicable state. Therefore, in the power-saving state before the power state returns, it may be preferable that communication can start with an inter integrated circuit (I2C) bus with relatively low power consumption. With the above configuration, a process (e.g., initialization process) may be required for returning the power state is executed through the communication with the I2C bus, and then communication with the USB becomes possible.

However, with the above configuration, when communication with the I2C bus fails, communication with the USB cannot be performed. In the above case, a disadvantage arises that the signals (wakeup signal and state control signals) for returning the power state of the first controller 110 are not properly received. With the configuration of the present embodiment, there is unnecessary to succeed in communication with the I2C bus when the power state returns, so that the above-described disadvantage can be prevented.

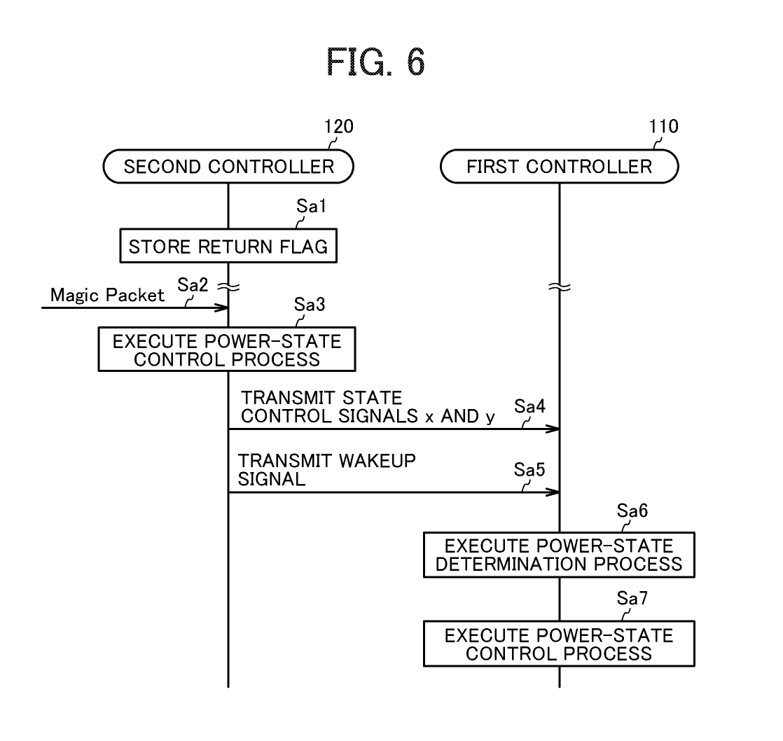

FIG. 6 is an explanatory sequence diagram of a specific example until the power state of the multifunction peripheral 100 (the first controller 110 and the second controller 120) returns.

As described above, the second controller 120 stores the return flags before the power state returns (Sa1 in FIG. 6). Then, when the magic packet is input to the second controller 120 (Sa2 in FIG. 6), the second controller 120 executes a power-state control process (Sa3 in FIG. 6).

In the power-state control process, the second controller 120 returns to the power state corresponding to the return flag. For example, when the return flag “4” is stored in step Sa1 described above, the power state of the second controller 120 returns to the liquid-crystal ON state in the subsequent power-state control process. On the other hand, when any of the return flag “1” to the return flag “3” is stored in step Sa1, the power state of the second controller 120 returns to the liquid-crystal OFF state in the subsequent power-state control process.

After executing the power-state control process, the second controller 120 transmits state control signals (x and y) to the first controller 110 (Sa4 in FIG. 6). Furthermore, the second controller 120 transmits the wakeup signal to the first controller 110 (Sa5 in FIG. 6).

The timing at which the second controller 120 executes the power-state control process can be appropriately changed. For example, the power-state control process may be executed after the transmission of the state control signals and the wakeup signal. Furthermore, the wakeup signal may be transmitted before the state control signals.

When receiving the wakeup signal, the first controller 110 executes a power-state determination process (Sa6 in FIG. 6). In the power-state determination process, the first controller 110 checks the state control signals (x and y) received from the second controller 120 and determines the power state according to the state control signals. For example, when receiving the state control signal x in the OFF state and the state control signal y in the OFF state, the first controller 110 determines the standby state (see FIG. 5 described above).

After executing the power-state determination process, the first controller 110 executes a power-state control process (Sa7 in FIG. 6). Specifically, in the power-state control process, the first controller 110 returns to the power state determined by the power-state determination process.

### Second Embodiment

Second and third embodiments of the present disclosure will be described below. In the following embodiments, elements having operation and functions equivalent to elements of the first embodiment are denoted by the same reference numerals used in the description of the first embodiment, and the detailed description of the elements is appropriately omitted.

In the above-described first embodiment, the return flag is stored in advance in the second controller 120 (return flag storage 122). When the magic packet is input to the second controller 120, the state control signals (x and y) corresponding to the return flags are output to the first controller 110 together with the wakeup signal. The first controller 110 returns to a power state corresponding to the state control signals.

In the second embodiment, in addition to second controller 120, a return flag is stored in first controller 110. Furthermore, the first controller 110 can receive a magic packet from a network N. When the magic packet is received by the first controller 110, a state control signal (z) corresponding to the return flag is output to the second controller 120 together with a wakeup signal. The second controller 120 returns to a power state corresponding to the state control signals.

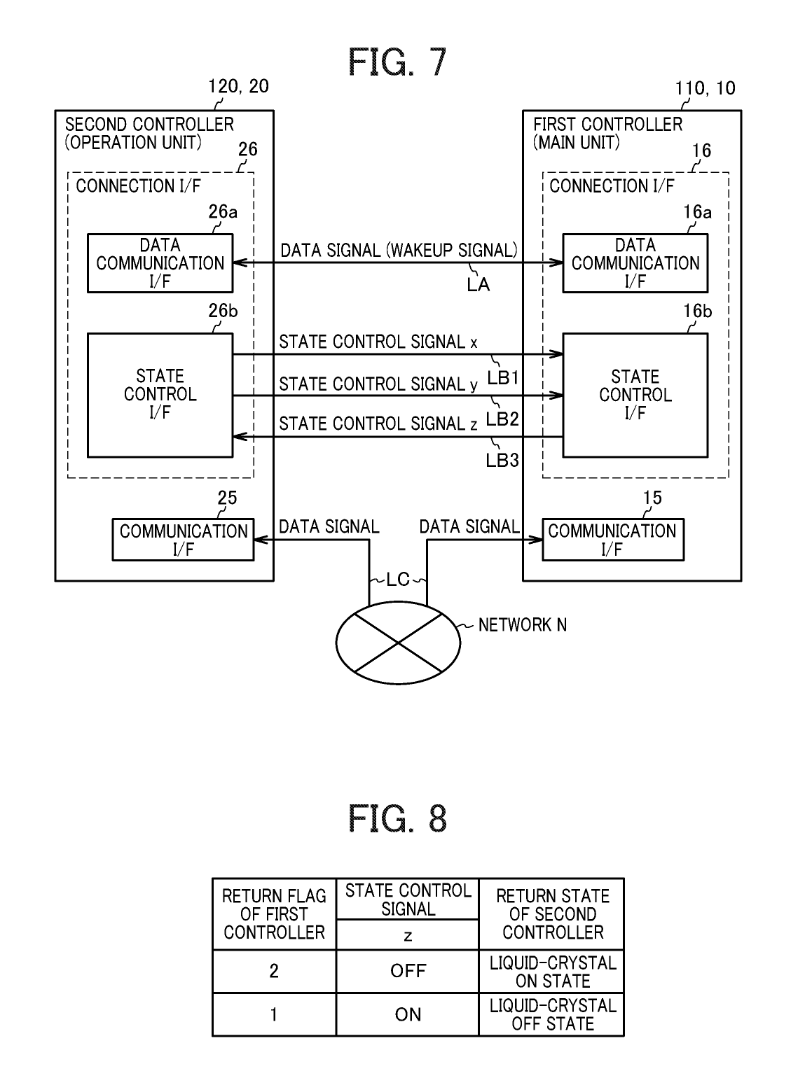

FIG. 7 is an explanatory diagram of an example of various signals in the second embodiment. FIG. 7 of the second embodiment corresponds to FIG. 2 of the above-described first embodiment.

As illustrated in FIG. 7, a connection I/F 16 of the first controller 110 in the second embodiment includes a data communication I/F 16a and a state control I/F 16b, similarly to the above-described first embodiment. Furthermore, a connection I/F 26 of the second controller 120 in the second embodiment includes a data communication I/F 26a and a state control I/F 26b, similarly to the first embodiment.

A second signal line LB of the second embodiment includes a second signal line LB3, in addition to a second signal line LB1 and a second signal line LB2 described in the first embodiment. In the second embodiment, in order to return the power state of the second controller 120, a wakeup signal is output from the data communication I/F 16a of the first controller 110 and a state control signal z is output from the state control I/F 16b of the first controller 110. The state control signal z is input to the state control I/F 26b of the second controller 120 via the second signal line LB3.

The first controller 110 may be provided with an I/F from which the state control signal z is output, separately from the state control I/F 16b to which a state control signal x and a state control signal y are input. Furthermore, the second controller 120 may be provided with an I/F to which the state control signal z is input, separately from the state control I/F 26b from which the state control signal x and the state control signal y are output.

The state control signal z is switched to an ON state or an OFF state similarly to the state control signal x and the state control signal y. When the wakeup signal is input, the second controller 120 of the second embodiment determines as to which state the power state returns to, in accordance with the state control signal z.

FIG. 8 an explanatory diagram of the return flag stored by the first controller 110, the state of the state control signal z when the wakeup signal is transmitted, and the transition of the power state of the second controller 120 (power state after return) when the state control signal z is input. That is, in FIG. 5 of the above-described first embodiment, there has been described the power state to which the first controller 110 returns in accordance with the state control signals (x and y). However, in FIG. 8 of the second embodiment, there will be described the power state to which the second controller 120 returns in accordance with the state control signal z.

Similarly to the second controller 120 of the first embodiment, the first controller 110 of the second embodiment stores the return flag. In accordance with the return flag in the first controller 110, the power state to which the second controller 120 returns is defined. For example, the return flag is stored in the first controller in accordance with an appropriate user operation to the operation panel 27 as described above. In another example, the return flag us stored in the multifunction peripheral 100 in its development stage (before shipment) so that the user cannot change the return flag.

Return flags stored in the first controller 110 include a return flag “1” corresponding to a liquid-crystal ON state of the second controller 120 (see FIG. 4 above described) and a return flag “2” corresponding to a liquid-crystal OFF state of the second controller 120 (see FIG. 4). As illustrated in FIG. 8, when the return flag is “1”, the first controller 110 outputs a state control signal z in the OFF state to the second controller 120. When the return flag is “2”, the first controller 110 outputs a state control signal z in the ON state to the second controller 120.

As illustrated in FIG. 8, when the wakeup signal is input to the second controller 120 and the state control signal z in the OFF state is input to the second controller 120, the power state of the second controller 120 returns to the liquid-crystal ON state. When the wakeup signal is input to the second controller 120 and the state control signal z in the ON state is input to the second controller 120, the power state of the second controller 120 returns to the liquid-crystal OFF state.

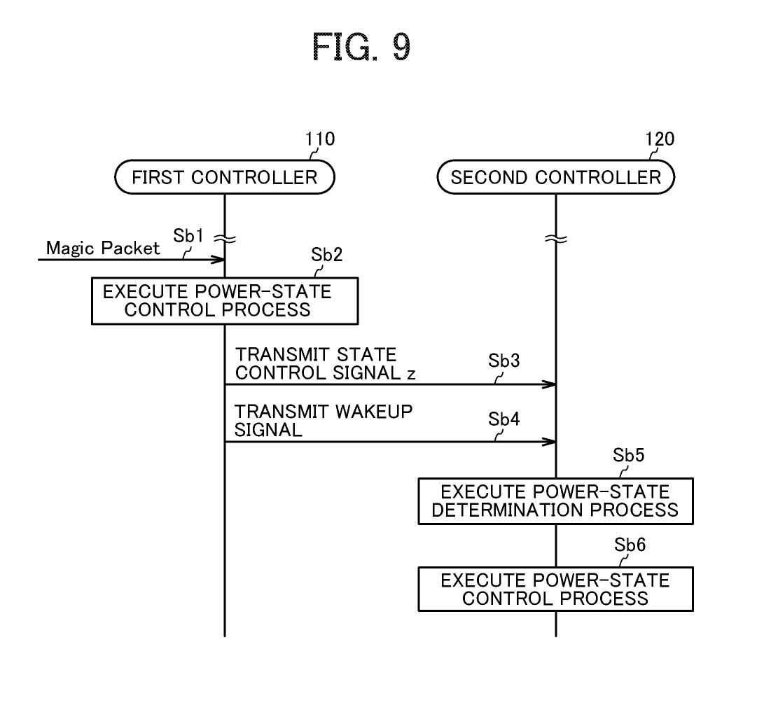

FIG. 9 is an explanatory sequence diagram of a specific example until the power state of the multifunction peripheral 100 (the first controller 110 and the second controller 120) returns. In the specific example of FIG. 6 in the above-described first embodiment, the magic packet is externally input (from network N) to the second controller 120, the wakeup signal and the state control signals (x and y) are input from the second controller 120 to the first controller 110. FIG. 9 illustrates a specific example in which a magic packet is externally input to the first controller 110.

When the magic packet is input to the first controller 110 (Sb1 in FIG. 9), the first controller 110 executes a power-state control process (Sb2 in FIG. 9). In the above power-state control process, the first controller 110 returns to any of a standby state, a low-power state, a silent state, and an engine-OFF state.

For example, when the first controller 110 stores the return flag “l” (when the second controller 120 returns to the liquid-crystal ON state), the power state of the first controller 110 returns to any of the engine-OFF state, the silent state, and the low-power state. One of the above states to which the power states is to returns is determined in advance.

When the first controller 110 stores the return flag “2” (when the second controller 120 returns to the liquid-crystal OFF state), the power state of the first controller 110 returns to the standby state. However, the power state to which the first controller 110 transitions when the return flags (1 and 2) are each stored may be appropriately changed.

After executing the power-state control process, the first controller 110 transmits the state control signal z to the second controller 120 (Sb3 in FIG. 9). Furthermore, the first controller 110 transmits the wakeup signal to the second controller 120 (Sb4 in FIG. 9).

The timing at which the first controller 110 executes the power-state control process (Sb2) can be appropriately changed. For example, the power-state control process may be executed after the state control signal z and the wakeup signal are transmitted. Furthermore, the wakeup signal may be transmitted before the state control signal z.

When receiving the wakeup signal, the second controller 120 executes a power-state determination process (Sb5 in FIG. 9). In the power-state determination process, the second controller 120 checks the state control signal z received from the first controller 110 to determine the power state according to the state control signal z. For example, when receiving the state control signal z in the OFF state, the second controller 120 determines the liquid-crystal ON state (see FIG. 8 described above).

After executing the power-state determination process, the second controller 120 executes a power-state control process (Sb6 in FIG. 9). Specifically, in the power-state control process, the second controller 120 returns to the power state determined by the power-state determination process.

In the above second embodiment, effects similar to the effects of the above-described first embodiment can be obtained. In the first embodiment and the second embodiment, the magic packet from the network N is received by the first controller 110 (the main unit 10) and the second controller 120 (the operation unit 20). However, the first controller 110 and the second controller 120 may each receive a magic packet from a different network capable of transmitting the magic packet. For example, a magic packet from a first network N1 may be received by the first controller 110, and another magic packet from a second network N2 different from the first network may be received by the second controller 120.

### Third Embodiment

In the above described first embodiment and second embodiment, the plurality (two or three) of second signal lines LB is provided, and the first controller 110 can return to any of three or more (four) power states. In the third embodiment, first controller 110 is caused to return to any of three or more power states via a single second signal line LB.

Specifically, in the third embodiment, the first controller 110 and second controller 120 are mutually connected via a first signal line LA and the single second signal line LB. In substantially the same manner as the first embodiment described above, a wakeup signal is input from the second controller 120 to the first controller 110 via the first signal line LA. In addition, similarly to the second embodiment described above, a wakeup signal is input from the first controller 110 to the second controller 120 via the first signal line LA.

The first controller 110 and the second controller 120 of the third embodiment perform serial communication via the second signal line LB.

For example, it is assumed that a wakeup signal is input from the second controller 120 to the first controller 110. In the above case, data in which a power state after return of the first controller 110 can be specified (hereinafter referred to as “post-return state data”) is input, by the serial communication, via the second signal line LB from the second controller 120 to the first controller 110. The post-return state data input from the first controller 110 to the second controller 120 includes data in which a standby state is specified, data in which a low-power state is specified, data in which a silent state is specified, and data in which an engine-OFF state is specified.

Upon receiving the wakeup signal, the first controller 110 analyzes the post-return state data received via the second signal line LB. Then, the first controller 110 transitions to the power state specified in the post-return state data.

On the other hand, it is assumed that a wakeup signal is input from the first controller 110 to the second controller 120. In the above case, post-return state data in which a power state after return of the second controller 120 can be specified is input, via the second signal line LB, from the first controller 110 to the second controller 120. The post-return state data input from the second controller 120 to the first controller 110 includes data in which a liquid-crystal OFF state is specified and data in which a liquid-crystal ON state is specified.

Upon receiving the wakeup signal, the second controller 120 analyzes the post-return state data received via the second signal line LB. Then, the second controller 120 transitions to the power state specified in the post-return state data.

According to the above third embodiment, effects similar to the effects of the above-described first embodiment and second embodiment can be obtained. Furthermore, according to the third embodiment, the first controller 110 is caused to return to any of three or more power states via the single second signal line LB. Therefore, there is an advantage that the number of the second signal lines LB can be reduced, as compared with the first embodiment and the second embodiment, for example.

According to a first aspect, there is provided an information processing apparatus including: a first controller (first controller 110) that transitions to any of power states including a first power state (STR state), a second power state (engine-OFF state) having higher power consumption than the first power state, and a third power state (silent state) having higher power consumption than the second power state; and a second controller (second controller 120) capable of inputting a first signal (wakeup signal) to the first controller via a first communication channel (first signal line LA), the second controller being capable of inputting a second signal (state control signal) to the first controller via a second communication channel (second signal line LB) different from the first communication channel, in which when the first signal is input in the first power state, the first controller determines, in accordance with the second signal, whether to transition to the second power state or the third power state (see FIG. 5).

According to the present aspect, the post-return power state of the information processing apparatus can be changed in accordance with the second signal.

The information processing apparatus according to a second aspect, in which the second communication channel includes a plurality of signal lines (second signal line LB1 and second signal line LB2), and the first controller determines which power state to transition to, in accordance with a combination of signals received via the plurality of signal lines.

According to the present aspect, the number of types of the post-return power state can be increased, for example, as compared with a configuration in which the post-return power state is determined in accordance with a signal (ON state/OFF state) of a single signal line.

The information processing apparatus according to a third aspect, in which the first communication channel includes a signal line of an Ethernet (registered trademark) standard for transmission of various signals including the first signal, and the second communication channel includes a dedicated signal line for transmission of the second signal.

According to the present aspect, the number of signal lines can be reduced, for example, as compared with a configuration in which a signal line for transmission of various signals is provided separately from the signal line for transmission of the first signal.

According to a fourth aspect, there is provided an information processing method including: causing a first controller to transition to any of power states including a first power state, a second power state having higher power consumption than the first power state, and a third power state having higher power consumption than the second power state, and inputting a first signal from a second controller to the first controller via a first communication channel (Sa4 in FIG. 6), and inputting a second signal from the second controller to the first controller via a second communication channel different from the first communication channel (Sa5 in FIG. 6), in which the information processing method includes, when the first signal is input to the first controller in the first power state, determining, in accordance with the second signal, whether to cause the first controller to transition to the second power state or the third power state (Sa7 in FIG. 6).

According to the present aspect, similarly to the above-described first aspect, the post-return power state of the information processing apparatus can be changed in accordance with the second signal.

According to a fifth aspect, there is provided a non-transitory storage medium storing a program for causing a computer to execute each process in the information processing method according to the fourth aspect.

According to the present aspect, similarly to the above-described first aspect, the post-return power state of the information processing apparatus can be changed in accordance with the second signal.

According to one or more embodiments of the present disclosure, the post-return power state of the information processing apparatus can be changed.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information processing apparatus comprising:
first circuitry configured to transition to one of power states including a first power state, a second power state having higher power consumption than the first power state, and a third power state having higher power consumption than the second power state; and
second circuitry configured to input a first signal to the first circuitry via a first communication channel and input a second signal to the first circuitry via a second communication channel, the second communication channel being different from the first communication channel, wherein
when the first signal is input in the first power state, the first circuitry determines, in accordance with the second signal, which one of the second power state and the third power state to transition to.

2. The information processing apparatus according to claim 1, wherein
the second communication channel includes a plurality of signal lines, and
the first circuitry determines one of the power states to transition to, in accordance with a combination of signals received via the plurality of signal lines.

3. The information processing apparatus according to claim 1, wherein
the first communication channel includes a signal line of an Ethernet (registered trademark) standard for transmission of various signals including the first signal, and
the second communication channel includes a dedicated signal line for transmission of the second signal.

4. An information processing method comprising:
causing first circuitry to transition to one of power states including a first power state, a second power state having higher power consumption than the first power state, and a third power state having higher power consumption than the second power state; and
inputting a first signal from second circuitry to the first circuitry via a first communication channel; and
inputting a second signal from the second circuitry to the first circuitry via a second communication channel, the second communication channel being different from the first communication channel,
wherein the information processing method includes, when the first signal is input to the first circuitry in the first power state, determining, in accordance with the second signal, which one of the second power state and the third power state the first circuitry is caused to transition.

5. A non-transitory storage medium storing a program for causing a computer to the information processing method according to claim 4.

6. An information processing apparatus comprising:
circuitry configured to transition to one of power states including a first power state, a second power state having higher power consumption than the first power state, and a third power state having higher power consumption than the second power state;
a first interface configured to receive a first signal from an external device via a first communication channel; and
a second interface configured to receive a second signal from the external device via a second communication channel, the second communication channel being different from the first communication channel, wherein
in response to receiving the first signal in the first power state, the circuitry transitions to one of the second power state and the third power state, in accordance with the second signal.
